(19) United States
(12) Patent Application Publication
(10) Pub. No.: US 2025/0387707 A1
(43) Pub. Date: Dec. 25, 2025

(54) METHOD, APPARATUS AND STORAGE MEDIUM FOR PICKING UP VIRTUAL PROP

(71) Applicant: NETEASE (HANGZHOU) NETWORK CO., LTD., Hangzhou (CN)

(72) Inventors: Ruijia ZHANG, Hangzhou (CN); Yuanyuan ZHU, Hangzhou (CN)

(21) Appl. No.: 18/850,968

(22) PCT Filed: Nov. 16, 2022
(86) PCT No.: PCT/CN2022/132380

§ 371 Date: Sep. 8, 2025

(30) Foreign Application Priority Data
Jun. 17, 2022 (CN) 202210693562.3

(51) Int. Cl. A63F 13/57

(52) U.S. Cl. CPC A63F 13/57

(57) ABSTRACT

The present disclosure provides a method for picking up a virtual prop. The method includes: determining at least one candidate virtual prop from among one or more virtual props in a game scene, the candidate virtual prop being configured with a virtual interaction object, where the game scene, the one or more virtual props and a game character are displayed on a graphical user interface of a terminal; in response to a view direction of a game view screen corresponding to the game character pointing toward the virtual interaction object, determining a target virtual prop corresponding to the virtual interaction object from among the at least one candidate virtual prop; and in response to a pickup operation for the target virtual prop, controlling the game character to pick up the target virtual prop.

The present disclosure is a 371 national phase application of PCT Application No. PCT/CN2022/132380 filed Nov. 16, 2022, which claims priority to Chinese Patent Application No. 202210693562.3 filed on Jun. 17, 2022, entitled “Method and Apparatus for Picking Up a Virtual Prop, Computer Device, and Storage Medium”, the entire contents of both of which are hereby incorporated by reference for all purposes.

### TECHNICAL FIELD

The present disclosure relates to the field of game technology, and in particular, to a method and apparatus for picking up a virtual prop, a computer device, and a storage medium.

### BACKGROUND

In some games, a rich variety of virtual props may be included in the game scene, and a user may play the game by controlling a game character to pick up virtual props in the game scene, for example, by clicking on the virtual props in the game scene.

However, in a complex game scene, the user can easily make a mistouch when controlling the game character to pick up a virtual prop.

### SUMMARY

According to a first aspect, the present disclosure provides a method for picking up a virtual prop, the method comprising: determining at least one candidate virtual prop from among one or more virtual props in a game scene, the at least one candidate virtual prop being configured with a virtual interaction object, where the game scene, the one or more virtual props and a game character are displayed on a graphical user interface of a terminal; in response to a view direction of a game view screen corresponding to the game character pointing toward the virtual interaction object, determining a target virtual prop corresponding to the virtual interaction object from among the at least one candidate virtual prop; and in response to a pickup operation for the target virtual prop, controlling the game character to pick up the target virtual prop.

According to a second aspect, the present disclosure further provides a system, comprising one or more processors and one or more memories, the memory storing a plurality of computer-executable instructions. The one or more processors execute the instructions to perform the operations in the above method for picking up a virtual prop.

According to a third aspect, the present disclosure further provides non-transitory computer-readable storage medium, storing a plurality of instructions adapted to be loaded by one or more processors, to perform the operations in the above method for picking up a virtual prop.

### BRIEF DESCRIPTION OF THE DRAWINGS

### Brief Description of the Drawings

In order to more clearly illustrate the technical solutions in the embodiments of the present disclosure, the accompanying drawings used in the description of the embodiments will be briefly described below, and it is obvious that the accompanying drawings in the description below only represent some embodiments of the present disclosure, and for a person skilled in the art, other drawings can also be obtained from these drawings without the exercise of inventive effort.

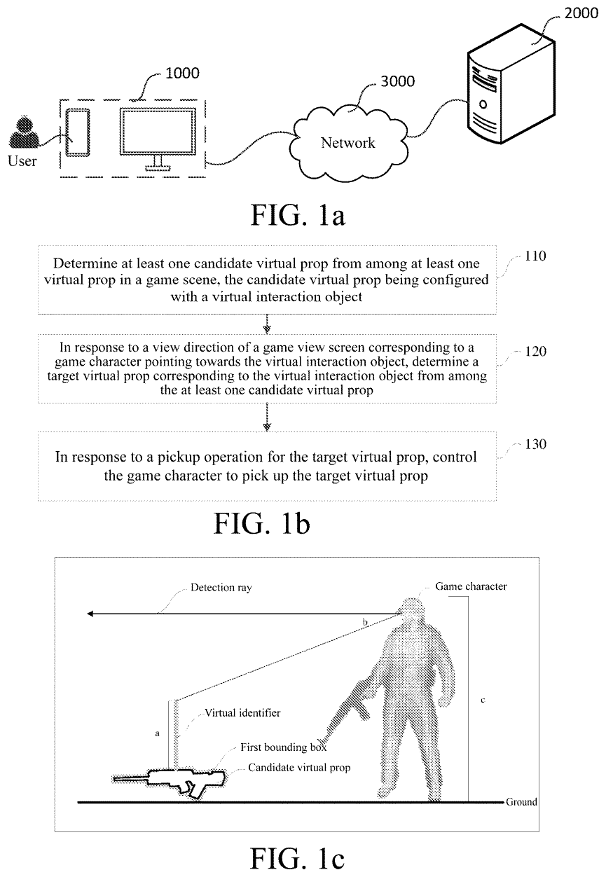

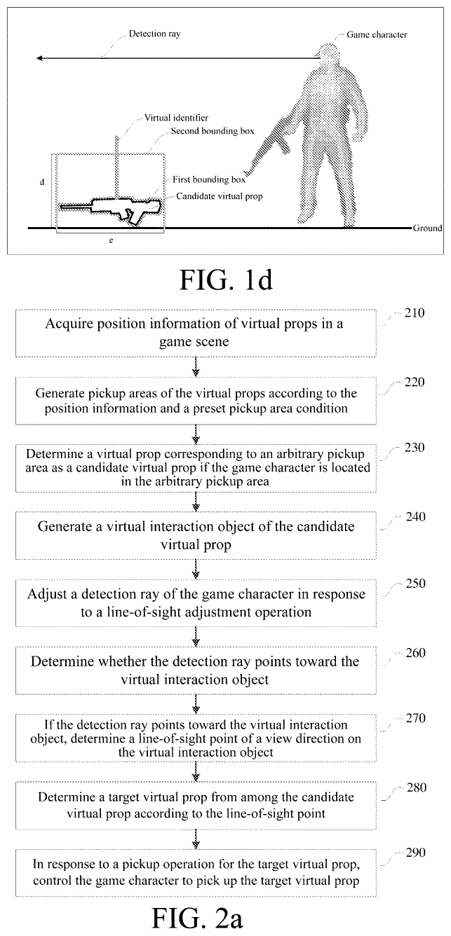

FIG. 1a is a schematic view of a scene of a system for picking up a virtual prop according to an embodiment of the present disclosure;

FIG. 1b is a schematic flowchart of a method for picking up a virtual prop according to an embodiment of the present disclosure;

FIG. 1c is a schematic diagram of a virtual identifier and a first bounding box according to an embodiment of the present disclosure;

FIG. 1d is a schematic diagram of a first bounding box according to an embodiment of the present disclosure;

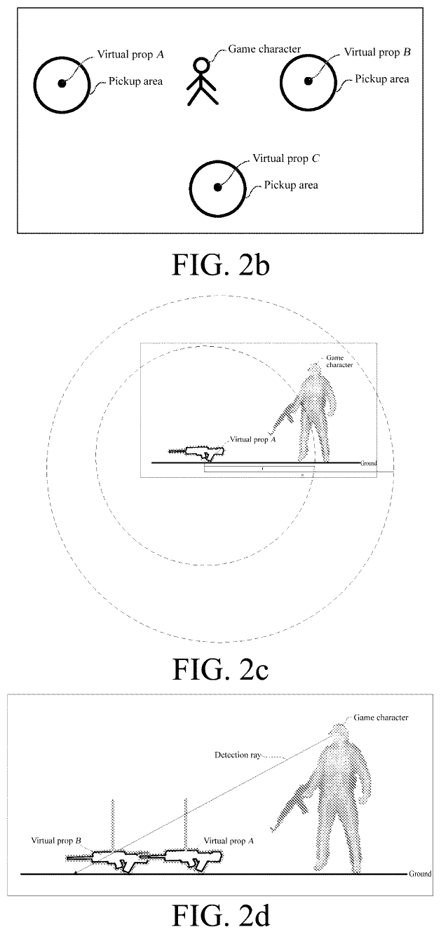

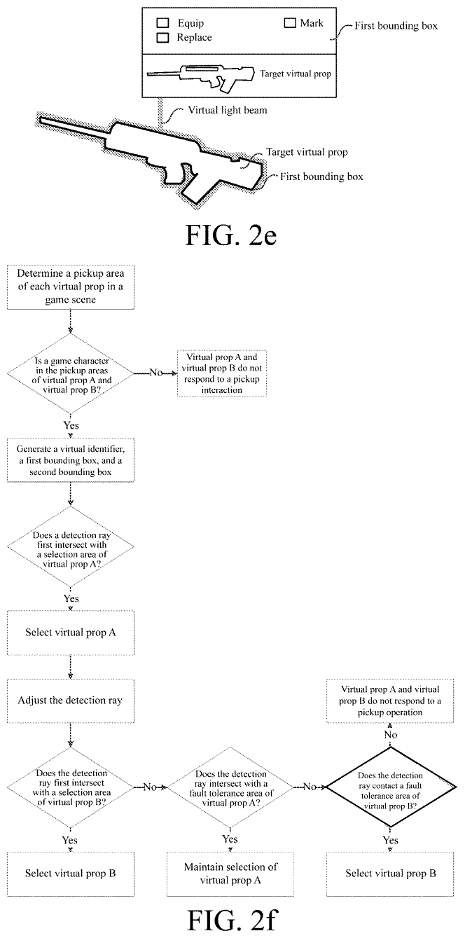

FIG. 2a is a schematic flowchart of a method for picking up a virtual prop according to another embodiment of the present disclosure;

FIG. 2b is a schematic diagram of pickup areas of virtual props according to an embodiment of the present disclosure;

FIG. 2c is a schematic diagram of a game character located in a pickup area according to an embodiment of the present disclosure;

FIG. 2d is a schematic diagram of a detection ray pointing toward selection areas of a virtual prop A and a virtual prop B according to an embodiment of the present disclosure;

FIG. 2e is a schematic diagram of a description interface for a target virtual prop according to an embodiment of the present disclosure;

FIG. 2f is a schematic flowchart of determining a target virtual prop according to an embodiment of the present disclosure;

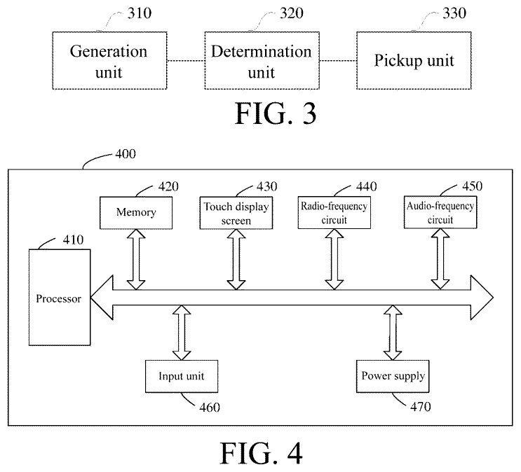

FIG. 3 is a schematic structural diagram of an apparatus for picking up a virtual prop according to an embodiment of the present disclosure; and

FIG. 4 is a schematic structural diagram of a computer device according to an embodiment of the present disclosure.

### EXAMPLES OF THE INVENTION

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

Embodiments of the present disclosure provide a method and apparatus for picking up a virtual prop, a computer device, and a storage medium, which can solve the problem in the prior art that a user easily makes a mistouch when controlling a game character to pick up a virtual prop, resulting in low pickup accuracy.

The embodiments of the present disclosure are capable of: determining at least one candidate virtual prop from among the at least one virtual prop in the game scene, the candidate virtual prop being configured with a virtual interaction object; in response to a view direction of a game view screen corresponding to the game character pointing toward the virtual interaction object, determining a target virtual prop corresponding to the virtual interaction object from among the at least one candidate virtual prop; and in response to a pickup operation for the target virtual prop, controlling the game character to pick up the target virtual prop. In the present disclosure, by means of the virtual interaction object configured for the candidate virtual prop, an interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

Before explaining the embodiments of the present disclosure in detail, some terms related to the embodiments of the present disclosure are explained.

Game scene: this refers to a game scene displayed (or provided) when an application runs on a terminal. The game scene may be a simulation environment for the real world, a semi-simulation and semi-imaginary virtual environment, or a purely imaginary virtual environment. The game scene may be any one of a two-dimensional game scene, a 2.5-dimensional game scene, or a three-dimensional game scene, and the dimensions of the game scene are not limited in the embodiments of the present disclosure. For example, a game scene may include sky, land, sea, etc., the land may include environmental elements such as a desert, a city, etc., and a user may control a game character to move in the game scene.

Game character: this refers to a character used to simulate a person or animal in the game scene. The game character may be a virtual character, a virtual animal, an animated character, etc., such as: persons and animals displayed in the game scene. The game character may be a virtual image representing the user in the game scene. A plurality of game characters may be included in the game scene, each game character having its own shape and volume in the game scene and occupying a portion of the space in the game scene. The motions of the game character may include: adjusting body posture, crawling, walking, running, riding, flying, jumping, aiming using a virtual fixture, shooting, driving, picking up, attacking, throwing, and releasing skills, etc.

In some embodiments, the content displayed on the graphical user interface at least partially includes a game scene, wherein the game scene includes at least one game character.

In some embodiments, the game characters in the game scene include a virtual character (player character) manipulated by the user, and a virtual character (non-player character, NPC) under system preset control and not manipulated by the user. In the present embodiment, the game character is a virtual character manipulated by the user.

In the present embodiment, the game character may be a virtual character controlled by the user through an operation on the client. In some examples, the game character may be a virtual person that competes in the game scene. In some examples, the number of game characters participating in the interaction in the game scene may be preset, or may be dynamically determined according to the number of clients participating in the interaction.

Virtual prop: this refers to a virtual prop that can be used by a game object in the game scene, including virtual weapons such as guns, rifles, sniper rifles, daggers, knives, swords, axes, and ropes that can hurt other virtual objects, replenishment tools such as bullets, defense tools such as shields, armor, and armored vehicles, virtual tools such as virtual light beams and virtual shock waves that are displayed by hand when a virtual object releases skills, and treatment tools such as medicine packages and beverages.

Game interface: this refers to an interface corresponding to an application provided or displayed through the graphical user interface, and the interface includes a graphical user interface for user interaction, and a game screen which is a screen of the game scene.

In some embodiments, the game interface may include game controls (e.g., skill controls, movement controls, character controls, and function controls such as backpack controls, chat controls, and system setting controls.), indicators (e.g., direction indicators, character indicators, etc.), and information display areas (e.g., number of kills, match time, etc.).

The embodiments of the present disclosure provide a method and apparatus for picking up a virtual prop, a computer device, and a storage medium.

The apparatus for picking up a virtual prop may be integrated in an electronic device, and the electronic device may be a terminal, a server, or the like. The terminal may be a device such as a mobile phone, a tablet computer, a smart Bluetooth device, a notebook computer, or a PC (personal computer). The server may be a single server or a server cluster composed of a plurality of servers.

In some embodiments, the apparatus for picking up a virtual prop may also be integrated in a plurality of electronic devices. For example, the apparatus for picking up a virtual prop may be integrated in a plurality of servers, which implement the method for picking up a virtual prop of the present disclosure.

In some embodiments, the method for picking up a virtual prop may run on a terminal device or server. The terminal device may be a local terminal device. When the method for picking up a virtual prop is run on a server, the method may be implemented and executed based on a cloud interaction system, wherein the cloud interaction system includes a server and a client device.

In an optional embodiment, various cloud applications may be executed under the cloud interaction system, for example: cloud games. Using a cloud game as an example, a cloud game refers to a game mode based on cloud computing. In the running mode of the cloud game, the running body of the game program and the game screen presentation body are separate, the storage and running of the method for picking up a virtual prop are performed on the cloud game server, and the client device is configured to receive and send data and present the game screen. For example, the client device may be a display device having a data transmission function near the user side, such as a terminal, a television, a computer, and a handheld computer. However, the terminal device that performs character control is a cloud game server on the cloud side. When playing a game, the user operates the client device to send an operation instruction, such as an operation instruction of a touch operation, to the cloud game server. The cloud game server runs the game according to the operation instruction, encodes and compresses the data such as a game screen, and returns the data to the client device through a network. Finally, the game screen is decoded and outputted by the client device.

In some embodiments, the server may also be implemented in the form of a terminal.

In an optional embodiment, the terminal device may be a local terminal device. Using a game as an example, the local terminal device stores a game program and is configured to present a game screen. The local terminal device is configured to interact with the user via the graphical user interface, i.e., the game program is downloaded, installed, and run conventionally via an electronic device. The graphical user interface may be provided to the user by the local terminal device in a variety of ways. For example, it may be rendered on the display screen of the terminal, or provided to the user by means of holographic projection. For example, the local terminal device may include a display screen for presenting a graphical user interface including a game screen, and a processor for running the game, generating the graphical user interface, and controlling the display of the graphical user interface on the display screen. The user can operate on the interface through an input device such as a touch screen, a mouse, a keyboard, or a handle.

For example, referring to FIG. 1a, some embodiments provide a schematic view of a scene of a system for picking up a virtual prop, wherein the system may implement a method for picking up a virtual prop. The system for picking up a virtual prop may include a terminal 1000, a server 2000, and a network 3000.

The terminal is configured to determine at least one candidate virtual prop from among at least one virtual prop in the game scene, the candidate virtual prop being configured with a virtual interaction object; in response to a view direction of a game view screen corresponding to a game character pointing toward the virtual interaction object, determine a target virtual prop corresponding to the virtual interaction object from among the at least one candidate virtual prop; and in response to a pickup operation for the target virtual prop, control the game character to pick up the target virtual prop. The server is configured to acquire the data of a game played by the user at the terminal. The network is used for data transmission between the server and the terminal, and the network may be a wireless network or a wired network. For example, the wireless network is a wireless local area network (WLAN), a local area network (LAN), a cellular network, a 2d network, a 3G network, a 4G network, a 5G network, or the like.

Each will be described in detail below. It is to be understood that, in the embodiments of the present disclosure, related data such as user operation, game data, and the like are involved. When the embodiments of the present disclosure are applied to a specific product or technology, the user's permission or consent needs to be obtained, and the collection, use, and processing of the related data needs to comply with relevant laws and regulations and standards in relevant countries and regions.

In the present embodiment, a method for picking up a virtual prop is provided. A graphical user interface is provided by a terminal, and the content displayed on the graphical user interface at least partially includes a game scene, and a game character and at least one virtual prop located in the game scene. As shown in FIG. 1b, a specific process of the method for picking up a virtual prop may be as follows:

110. At least one candidate virtual prop is determined from among the at least one virtual prop in the game scene, the candidate virtual prop being configured with a virtual interaction object.

The at least one virtual prop may refer to a virtual prop that can be picked up after the user controls the game character to perform a pickup operation in the game scene. Before performing the pickup operation, the game object may be moved into a pickup-enabled range of the virtual prop by a moving operation.

The candidate virtual prop may refer to one or more virtual props determined from among the at least one virtual prop according to a user operation or a preset selection rule. For example, the user operation may be a selection operation or a marking operation on at least one virtual prop in the game scene, and the preset selection rule may be a rule set in advance according to position information, type information, and the like of the candidate virtual prop. For example, the preset selection rule may be that a virtual prop in a game scene located in a pickup range of the game object is determined as a candidate virtual prop, or that a virtual prop in the game scene in which the type information matches the game object is determined as a candidate virtual prop, and so on. Specifically, for example, if the virtual prop equipped by game object lacks a head protector and a treatment medicine package, the virtual props for the head protector and the treatment medicine package in the game scene may be determined as candidate virtual props. It should be noted that the candidate virtual prop may be regarded as a virtual prop in a pickup-enabled state, and the virtual prop in the pickup-enabled state may perform pickup interaction with a view direction of a game view screen, to adjust the pickup-enabled state to a pickup waiting state in response to the view direction of the game view screen pointing toward the virtual interaction object.

The virtual interaction object may refer to a virtual object that is used by the candidate virtual prop to perform pickup interaction with the game character controlled by the user. For example, the virtual interaction object may include, but is not limited to, a virtual identifier or a bounding box, etc. Configuring a virtual interaction object for a candidate virtual prop may refer to generating and displaying a virtual interaction object corresponding to each candidate virtual prop in the game scene.

If there are a game character and a candidate virtual prop in the game scene, a virtual interaction object of the candidate virtual prop may be generated, so as to determine a target virtual prop from among the candidate virtual prop according to the result of interaction between the view direction of the game character and the virtual interaction object. In a practical application, the display effect or the shape/size of the virtual interaction object may be set, for example, by highlighting the virtual interaction object or displaying same in a special shape, so as to increase the precision of selecting any candidate virtual prop, to improve the accuracy of picking up the virtual prop.

In some embodiments, determining at least one candidate virtual prop from among the at least one virtual prop in the game scene may include:
acquiring prop position information of a virtual prop in the game scene;
generating a pickup area of the virtual prop according to the prop position information and a preset pickup area condition; and
if the game character is located within an arbitrary pickup area, determining at least one virtual prop corresponding to the arbitrary pickup area as a candidate virtual prop.

The preset pickup area condition may refer to a preset condition for setting a pickup area of the virtual prop, and the pickup area may refer to an area or a range in which the virtual prop can be picked up in the game scene. For example, the preset pickup area condition may include a pickup radius, and a spherical or circular pickup area having a radius of the pickup radius may be set in the game scene, using the position information of the virtual prop as the center.

Generally, there will be a plurality of virtual props in a game scene. In order to obtain a pickup-enabled candidate virtual prop from among a plurality of game props available for pickup, to improve the effectiveness and efficiency of picking up the virtual prop, and to reduce the server waste, a pickup area of the virtual prop may be generated in the game scene according to the preset pickup area condition and the position information of the virtual prop. When the user controls a game character to enter the pickup area of any virtual prop, the state of the virtual prop may be set to a pickup-enabled state when the game character may interact with the virtual prop, for example, to view the virtual prop, pick up the virtual prop, etc.

In some embodiments, the pickup area may be in the form of a bounding box, such as a spherical bounding box having a radius of the pickup radius. By using a simply structured bounding box to set the pickup area, the pickup area can be generated more quickly, the efficiency of determining the pickup interaction area can be improved, and the pickup interaction process can be simplified, to improve the pickup efficiency of the prop.

In some embodiments, different pickup radii may be set for different virtual props according to the types of the virtual props or the game scene. The smaller the pickup radius, the closer the game character needs to be to the virtual prop to perform the pickup operation, which takes more time and makes the game more difficult. Therefore, various ways can be provided for picking up the virtual props, thereby improving the user retention rate and reducing the server waste. For example, small to large pickup radii may be set, in order, for virtual weapons, defense props, replenishment props, and treatment props. For another example, different pickup radii may be set according to different terrain in the game scene. For example, a smaller pickup radius may be set for complex terrain such as a mountainous region and a rain forest, while a larger pickup radius may be set for simple terrain such as a desert and a plain, so as to increase the difficulty of picking up virtual props in the complex terrain and improve the realism of the game.

In some embodiments, there may be a plurality of game characters in the pickup area of the same virtual prop. In order to increase the degree of dispersion of the plurality of game characters in the same pickup area, the size of the pickup area may be adjusted according to the number of game characters in the pickup area, so that the plurality of game characters are dispersed in the pickup area, thereby avoiding view blocking and improving the visual effect. Specifically, the preset pickup area condition may include a pickup radius, and generating a pickup area of the virtual prop according to the position information and the preset pickup area condition may include: generating an initial pickup area according to the position information and the pickup radius; and adjusting the initial pickup area according to the number of game characters in the initial pickup area, to obtain a pickup area of the virtual prop. For example, the pickup radius is r, the initial pickup area has a size of 2πr, there are a game characters in the initial pickup area, and the size of the pickup area is 2πr(1+a/b), where b may be a preset parameter, e.g., b=10. The center point of the initial pickup area and the center point of the pickup area are both the position of the virtual prop in the game scene.

In some embodiments, before, in response to a view direction of a game view screen corresponding to the game character pointing toward the virtual interaction object, determining a target virtual prop corresponding to the virtual interaction object from among the at least one candidate virtual prop, the method may further include:
adjusting the view direction in response to a second view adjustment operation.

The view adjustment operation may refer to an operation for adjusting the view direction of the game view screen, and a line-of-sight adjustment operation may include, but is not limited to, operations such as touch, drag, swipe, long press, short press, double click, click, and drag end. The user can perform the line-of-sight adjustment operation through an input device such as a touch screen, a mouse, a keyboard, or a handle, and the specific operation mode depends on the game operation method or specific settings of the game. For example, in a third-person game, a line-of-sight adjustment control may be provided on a game interface of the graphical user interface of the terminal, and in response to a touch operation acting on the line-of-sight adjustment control, the game character may be controlled to move its head, for example, to raise or lower its head, to adjust the view direction of the game view screen. By adjusting the view direction of the game view screen, it is possible to assist the user to quickly select a candidate virtual prop, improving the efficiency of picking up the virtual prop.

It should be noted that, in the embodiments of the present disclosure, a first view adjustment operation and the second view adjustment operation are operations respectively corresponding to the adjustment processes in different view directions, and the specific operation modes may be the same or different.

120. In response to a view direction of a game view screen corresponding to the game character pointing toward the virtual interaction object, a target virtual prop corresponding to the virtual interaction object is determined from among the at least one candidate virtual prop.

The view direction may refer to the direction that the view of the game character points toward in the game scene. For example, the view direction may be a perspective in the game scene, and the perspective in the game scene may be different according to specific settings of the game. For example, the perspective in the game scene may be a first-person perspective or a third-person perspective. The view direction of the game view screen pointing toward the virtual interaction object may be such that the view direction entirely or partially covers an area where the virtual interaction object is located.

When the game character is in the first-person perspective, the view direction of the game view screen may be a line-of-sight range of the game character in the game scene. For example, an eye of the game character may be used as an origin of the view direction of the game character, e.g., a conical area having a vertex at the midpoint of the eye of the game character. The view direction may also be a detection ray that is emitted by the game character and that points toward the line-of-sight direction of the game character, e.g., a detection ray emitted from the midpoint of the eye of the game character, etc. For another example, a camera model may be used as the line-of-sight origin. For example, the view direction may be a conical area emitted by the camera model, and the detection ray may be a detection ray emitted by the camera model and pointing toward the view direction of the game view screen. For example, when the game character is in the first-person perspective, the camera model is located on the head or neck of the game character, and when the game character is in the third-person perspective, the camera model is located behind the game character. Thus, the perspective is different, leading to different content displayed on the game screen, and the content on the game screen changes along with the changing position and/or line-of-sight direction of the game character in the three-dimensional game scene.

The target virtual prop may refer to a virtual prop in a pickup waiting state. The pickup waiting state may refer to a state where the virtual prop can be picked up by the game character in response to a pickup operation of the game character. For example, if the virtual prop is in the pickup waiting state, it may mean that the virtual prop is associated with a pickup control in the game interface. If the user performs a touch operation on the pickup control, the game character may be controlled to automatically pick up the virtual prop. As another example, the candidate virtual prop may also be highlighted so that the user can quickly find the target virtual prop from among the at least one virtual prop.

After the generation of the virtual interaction object of the candidate virtual prop, if the view direction of the game view screen is adjusted to point toward the virtual interaction object of any candidate virtual prop, it is considered that at least one candidate virtual prop is selected by adjusting the view direction of the game view screen, and thus the selected candidate virtual prop may be determined as the target virtual object. For example, the at least one candidate virtual prop may be determined as the target virtual prop if the view direction completely covers an area where the at least one candidate virtual prop is located, or if the detection ray points toward the center point of the at least one candidate virtual prop. In this way, by determining the target virtual prop according to the view direction of the game view screen and the virtual interaction object, the accuracy of picking up the virtual prop can be improved, and the user can be assisted to quickly determine the virtual prop to be picked up, thereby simplifying the process of picking up the virtual prop, achieving quick pickup, and improving the efficiency of picking up the virtual prop.

In some embodiments, the virtual interaction object may include at least one of a first object and a second object, and in response to a view direction of a game view screen corresponding to the game character pointing toward the virtual interaction object, determining a target virtual prop corresponding to the virtual interaction object from among the at least one candidate virtual prop may include: in response to a view direction of a game view screen corresponding to the game character pointing toward the first object or the second object, determining a target virtual prop corresponding to the virtual interaction object from among the at least one candidate virtual prop.

The first object and the second object are different virtual interaction objects, that is, each candidate virtual prop may be configured with one or more virtual interaction objects. An interaction area of the candidate virtual prop is determined by the first object and the second object, which can provide various means of interaction, to increase the user retention rate and reduce the server waste.

In some embodiments, the first object may include a virtual identifier, and before, in response to a view direction of a game view screen corresponding to the game character pointing toward the virtual interaction object, determining a target virtual prop corresponding to the virtual interaction object from among the at least one candidate virtual prop, the method may further include:
acquiring a line-of-sight height of the game view screen;
determining a display height of the virtual identifier of the candidate virtual prop according to the line-of-sight height; and
displaying the virtual identifier of the candidate virtual prop at the display height.

The virtual identifier may refer to an identifier used to characterize a target virtual object in the game scene, and may be presented in various forms, depending on the specific settings of the game. For example, the virtual identifier may be a figure having the same outline as the candidate virtual prop, and is highlighted in the game scene.

The line-of-sight height may be that of the game view screen in the game scene. For example, a camera model may be used as the line-of-sight origin, and the line-of-sight height may be the height of the camera model from the ground or floor in the game scene. For example, when the game character is in the first-person perspective, the camera model is located on the head or neck of the game character. When the game character is in a third-person perspective, the camera model is located behind the game character.

The display height may refer to the height of the virtual identifier in the game scene. For example, the line-of-sight height may be used as the display height, or the display height may be calculated according to the line-of-sight height, e.g., display height=c×(1/2), where c is the line-of-sight height, etc.

Since the virtual props in the game scene are generally scattered on the ground or other planes and are not easy to view, by displaying the virtual identifier in the game scene, on the one hand, the user can quickly find the candidate virtual prop and the virtual identifier of the candidate virtual prop in the game scene, improving the pickup efficiency of the virtual prop. On the other hand, the display height of the virtual identifier is determined according to the line-of-sight height of the game character, and the virtual identifier may be displayed at an easy-to-view height according to the line-of-sight height, further improving the pickup efficiency of the virtual prop.

In some embodiments, determining a display height of the virtual identifier of the candidate virtual prop according to the line-of-sight height may include:
acquiring a preset weight parameter; and
performing weight calculation on the line-of-sight height according to the preset weight parameter, to obtain a display height of the virtual identifier of the candidate virtual prop.

The preset weight parameter may depend on specific settings of the game. For example, the preset weight parameter may be a preset decimal less than 1. The display height of the virtual identifier is obtained by performing weight calculation on the line-of-sight height, at a high calculation speed. The display height of the virtual identifier may also be adjusted by adjusting the preset weight parameter quantization, which has a high processing efficiency and can facilitate the calculation.

In some embodiments, the display height may be a preset height. For example, the display height may be preset for each game character according to the line-of-sight height, so that the preset display height may be acquired according to the identifier of the game character, and the virtual identifier of the candidate virtual prop is displayed at the display height.

In some embodiments, in order to help the user find the virtual identifier and improve the pickup efficiency of the virtual prop, the virtual identifier may be a virtual light beam located above the candidate virtual prop. For example, as shown in FIG. 1c, the virtual identifier may be a virtual light beam extending upward from the midpoint of the candidate virtual prop, where the display height of the virtual light beam is a=c×(1/2), where c is the line-of-sight height, that is, the height of the virtual light beam is c×(1/2).

In this way, when the game character looks straight ahead, the view direction thereof does not point toward the virtual identifier. When the game character looks down at an angle of less than 45 degrees with the ground, the view direction thereof may point toward all or part of the virtual identifier. Thus, by setting the height of the light beam to be lower than the line-of-sight height, the game character will interact with the virtual identifier only under a certain perspective, thereby avoiding mistouch, increasing the fault tolerance, increasing the precision of selecting the virtual prop, and improving the accuracy of picking up the virtual prop.

In some embodiments, the first object may include a first bounding box, and the second object may include a second bounding box, the first bounding box being located within the second bounding box.

The bounding box may refer to a closed space that completely encloses a combination of objects, and enclosing complex objects in a simple bounding box can improve the efficiency of geometric operations. The bounding box may have a variety of shapes, depending on specific settings of the game. For example, a bounding box may be generated around the candidate virtual prop by means of an AABB bounding box (axis-aligned bounding box), a sphere, an OBB (oriented bounding box), and a FDH (fixed directions hulls or k-DOP). The first bounding box and the second bounding box are both generated on the periphery of the candidate virtual prop. For example, as shown in FIG. 1c and FIG. 1d, the first bounding box may be located on the periphery of the candidate virtual prop and has the same outline as the candidate virtual prop. As shown in FIG. 1d, the second bounding box may be a cylindrical bounding box on the periphery of the first bounding box.

Through generation of two bounding boxes of the candidate virtual prop, on the one hand, an interaction area of the candidate virtual prop is determined using the bounding boxes, where the interaction area is determined by approximately replacing the candidate virtual prop of a complex structure with the simply-structured bounding boxes, thereby improving the efficiency of determining the interaction area and simplifying the interaction process, to improve the pickup efficiency of the prop. On the other hand, an interaction area of the candidate virtual prop is determined by the two bounding boxes, which can provide various means of interaction, to increase the user retention rate and reduce the server waste.

In some embodiments, after determining at least one candidate virtual prop from among the at least one virtual prop in the game scene, the method may further include: determining an interaction area of the candidate virtual prop according to the virtual interaction object. The virtual interaction object may be located within the interaction area, and the view direction of the game view screen pointing toward the virtual interaction object may be such that the view direction of the game view screen points toward the interaction area of the candidate virtual prop.

The interaction area may refer to an area where the candidate virtual prop can perform a pickup interaction with the game character. For example, an area where the virtual interaction object is located in the game scene may also be determined as the interaction area, and the interaction area may also be determined according to the position information of the virtual interaction object and the candidate virtual prop in the game scene, etc. Specifically, two points of the virtual interaction object and the candidate virtual prop that are farthest away from each other in the game scene are identified, a line connecting the two points is taken as a diameter, and a spherical area drawn using the diameter in the game scene is determined as the interaction area. It should be noted that, if an area where the virtual interaction object is located in the game scene is determined as the interaction area, the virtual interaction object may be considered as an object that the candidate virtual prop uses to perform a pickup interaction with the game character. If the interaction area is an area where the virtual interaction object is located in the game scene, and if the virtual interaction object is a three-dimensional model in the game scene, the interaction area may be a three-dimensional space occupied by the virtual interaction object in the game scene.

In some embodiments, in response to a view direction of a game view screen corresponding to the game character pointing toward the first object or the second object, determining a target virtual prop corresponding to the virtual interaction object from among the at least one candidate virtual prop may include:
in response to a view direction of a game view screen corresponding to the game character pointing toward the first object, determining a target virtual prop corresponding to the first object from among the at least one candidate virtual prop;
or in response to the view direction not pointing toward the first object and the view direction pointing toward the second object, determining a target virtual prop corresponding to the second object from among the at least one candidate virtual prop.

The target virtual prop may be some or all of the candidate virtual props toward which the view direction points. For example, the target virtual prop may be all of the subsequent virtual props toward which the view direction points, or may be the first of the candidate virtual props toward which the view direction points.

For example, it may be determined whether the view direction of the game character points toward the virtual interaction object according to the line-of-sight point. The line-of-sight point may refer to a gaze point in the game scene along the view direction of the game view screen. For example, an intersection where the view direction of the game view screen meets any object in the game scene, such as a game character, a virtual prop, or other objects, may be determined as the line-of-sight point of the view direction in the game scene. For example, the line-of-sight point of the view direction of the game view screen on the virtual interaction object may be the intersection where the view direction of the game view screen meets the virtual interaction object. For another example, the line-of-sight point of the view direction of the game view screen on the virtual interaction object may also be an intersection where the view direction of the game view screen meets the interaction area of the virtual interaction object. When the game character is in a first-person perspective, the line-of-sight point may refer to the gaze point of the game character in the game scene.

For example, it may be determined whether or not the view direction of the game view screen intersects the virtual interaction object (whether or not there is an intersection). If so, it may be considered that the view direction of the game view screen points toward the virtual interaction object, that is, it may be considered that a candidate virtual prop corresponding to any virtual interaction object is selected by adjusting the view direction of the game view screen, when an intersection between the view direction and the virtual interaction object is acquired, and a target virtual prop is determined from among the candidate virtual prop according to the intersection. Thus, when the view direction is adjusted, the intersection can be calculated and the target virtual prop can be determined in real time, thereby improving processing efficiency.

For another example, it is determined whether or not the view direction of the game view screen points toward the virtual interaction object. For example, the position information of the line-of-sight origin and the position information of the candidate virtual prop in the game scene may be acquired, a connecting line between the line-of-sight origin and a virtual angle may be determined according to the acquired position information, an angle A between the connecting line and the horizontal direction of the game scene may be determined, and an angle B between the view direction of the game view screen and the horizontal direction of the game scene may be acquired. If the difference between the angle A and the angle B is less than a preset value, it may be considered that the view direction points toward the virtual interaction object. It may be further determined whether or not the view direction intersects the virtual interaction object (whether or not there is an intersection). If so, it is considered that the view direction points toward the virtual interaction object. Since both the candidate virtual prop and the game character are within the pickup range of the candidate virtual prop, when the angle A and the angle B are close to or even equal to each other, it can be considered that the view direction of the game character is likely to point toward the candidate virtual prop, then, through comparison of the angle A and the angle B, only the intersection of part of the view direction of the game character needs to be calculated, thereby improving processing efficiency and facilitating calculation.

The step of acquiring the position information of the line-of-sight origin in the game scene and the position information of the candidate virtual prop may include: acquiring the face orientation of the game character in the game scene, the position information of the game character, and the position information of the candidate virtual prop; determining a target direction according to the position information of the game character and the position information of the candidate virtual prop, where the target direction may refer to a direction in which the position of the game character points toward the position of the candidate virtual prop in a horizontal direction; and, acquiring the position information of the line-of-sight origin in the game scene if the face orientation of the game character is the same as the target direction. By determining the face orientation of the game character, it is possible to calculate only the intersection of the view direction when the face orientation is the same as the target direction, thereby further improving processing efficiency and facilitating calculation. Specifically, the angle B may be an angle between the center line of the view direction or the detection ray and the horizontal direction of the game scene.

In some embodiments, in response to a view direction of a game view screen corresponding to the game character pointing toward the first object, determining a target virtual prop corresponding to the first object from among the at least one candidate virtual prop may include:
in response to a view direction of a game view screen corresponding to the game character pointing toward the first objects, determining the first of the first objects toward which the view direction points; and
determining a target virtual prop corresponding to the first of the first objects from among the at least one candidate virtual prop.

The first of the first objects may refer to the first among the first objects which is in the view direction and toward which the view direction points, e.g., the first object that is closest to the line-of-sight origin.

If there are a plurality of candidate virtual props in the game scene, the view direction of the game view screen may point toward the virtual interaction object of one or more candidate virtual props. If the view direction of the game view screen points toward the virtual interaction objects of the plurality of candidate virtual props, there exist a plurality of first objects toward which the view direction points. Thus, the first among the first objects toward which the view direction points can be determined as the target virtual prop, and the user can be assisted to quickly select the candidate virtual prop, thereby improving the pickup efficiency of the virtual prop.

In some embodiments, the view direction may include a detection ray that is emitted from a preset position of the game view screen and that points toward the view direction, and in response to a view direction of a game view screen corresponding to the game character pointing toward the first objects, determining the first of the first objects toward which the view direction points may include:
determining a first intersection in response to the detection ray pointing toward at least one of the first objects, the first intersection being an intersection between the detection ray and the first object; and
according to position information of the first intersection, determining, from among the first objects, the first of the first objects toward which the view direction points.

The preset position may be a line-of-sight origin set according to game settings, e.g., the eye position of the game character, the position of a camera model for determining the view direction of the game view screen, or the like.

For example, it may be determined whether there is an intersection between the detection ray and the first object. If so, the first of the first objects is determined according to the intersection between the detection ray and the first object. For example, the first intersection closest to the line-of-sight origin or the game character may be determined as a target intersection, and the first object corresponding to the target intersection is determined as the first of the first objects. By setting the detection ray in the view direction of the game view screen, the detection ray can point toward the target interaction object more precisely, thereby avoiding mistouch, increasing the fault tolerance, and increasing the precision of selecting the virtual prop, to improve the accuracy of picking up the virtual prop.

For example, if there is an intersection between the detection ray and the virtual identifier, it may be considered that the detection ray points toward the virtual interaction object, at which time the target virtual prop can be determined through the intersection between the detection ray and the virtual identifier. On the one hand, the user can quickly find the candidate virtual prop and the virtual interaction object thereof through the virtual identifier. On the other hand, the user can accurately select the virtual interaction object by adjusting the detection ray to precisely point toward the virtual identifier, thereby improving the efficiency and accuracy of picking up the virtual prop.

For another example, when the detection ray simultaneously intersects the first bounding box A of the candidate virtual prop A and the first bounding box B of the candidate virtual prop B, the position information of the intersections where the detection ray respectively intersects the first bounding box A and the first bounding box B may be acquired, and the first bounding box corresponding to the point closest to the line-of-sight origin among the intersections may be determined as the first of the first objects. It should be noted that, if the detection ray points toward at least one second bounding box as well as a plurality of first bounding boxes, only the position information of the second intersection is acquired.

If the detection ray simultaneously intersects the first bounding box A of the candidate virtual prop A and the second bounding box B of the candidate virtual prop B, only the position information of the intersection between the detection ray and the first bounding box A is acquired, and the target intersection is determined from the intersection between the detection ray and the first bounding box A.

In some embodiments, the view direction may include a detection ray that is emitted from a preset position of the game view screen and that points toward the view direction, and in response to a view direction of a game view screen corresponding to the game character pointing toward the first objects, determining the first of the first objects toward which the view direction points may include:
determining the first object that is the first to respond to the detection ray as the first of the first object.

For example, if the detection ray intersects any one of the first objects when the detection ray is emitted from the line-of-sight origin, it may be considered that the first object responds to the detection ray. If there is a first object responding to the detection ray, the detection ray may be stopped from continuing to be extended, and the first object that responds first is determined as the first of the first objects, thereby improving processing efficiency and facilitating calculation.

In some embodiments, in response to the view direction not pointing toward the first object and the view direction pointing toward the second object, determining a target virtual prop corresponding to the second object from among the at least one candidate virtual prop may include:
in response to the view direction not pointing toward the first objects and the view direction pointing toward the second objects, determining the first of the second objects toward which the view direction points; and
determining a target virtual prop corresponding to the first of the second objects from among the at least one candidate virtual prop.

The first of the second objects may refer to the first among the second objects which is in the view direction and toward which the view direction points, e.g., the second object that is closest to the line-of-sight origin.

For example, the virtual interaction object may include a first bounding box and a second bounding box. Since the first bounding box occupies less space in the game scene than the second bounding box, when the user wants to select a candidate virtual prop by adjusting the detection ray, it is more difficult to adjust the detection ray to intersect with the first bounding box than with the second bounding box, and therefore, a method for determining a corresponding intersection may be provided according to the degree of difficulty of adjusting the detection ray to intersect the two bounding boxes. Specifically, if the adjusted detection ray intersects the first bounding box, it is considered that the candidate virtual prop corresponding to the first bounding box is selected through the detection ray. If the adjusted detection ray intersects the second bounding box, it is considered that the second bounding box may be erroneously selected, for which it needs to be further determined whether the detection ray intersects any first bounding box. Otherwise, it is considered that the candidate virtual prop corresponding to the second bounding box is selected through the detection ray. In this way, the precision of selecting the virtual prop can be increased, to improve the accuracy of picking up the virtual prop. In particular, when there are a plurality of candidate virtual props in the game scene, for example, if the detection ray intersects the first and second bounding boxes of the candidate virtual prop A and intersects the second bounding box of the candidate virtual prop A, the intersection between the detection ray and the first bounding box of the candidate virtual prop A may be determined as the target intersection. If the detection ray intersects the second bounding box of the candidate virtual prop A and does not intersect the first bounding box of any candidate virtual prop, the intersection between the detection ray and the second bounding box of the candidate virtual prop A may be determined as the target intersection.

In some embodiments, if there is only one candidate virtual prop, and the detection ray points toward the second object of the candidate virtual prop, the candidate virtual prop is determined as the target virtual prop. In this way, if there is only one candidate virtual prop in the game scene, the second object can assist the user to quickly select the candidate virtual prop, thereby improving the pickup efficiency of the virtual prop.

In some embodiments, the view direction may include a detection ray that is emitted from a preset position of the game view screen and that points toward the view direction, and in response to the view direction not pointing toward the first objects and the view direction pointing toward the second objects, determining the first of the second objects toward which the view direction points may include:
determining second intersections in response to the detection ray not pointing toward the first objects and the detection ray pointing toward the second objects, the second intersections being intersections between the detection ray and the second objects; and
according to position information of the second intersections, determining, from among the second objects, the first of the second objects toward which the view direction points.

For example, when the detection ray simultaneously intersects the second bounding box A of the candidate virtual prop A and the second bounding box B of the candidate virtual prop B, the position information of the intersections where the detection ray respectively meets the second bounding box A and the second bounding box B may be acquired, and the second bounding box corresponding to the point closest to the line-of-sight origin among the intersections may be determined as the first of the second objects.

In some embodiments, the view direction may include a detection ray that is emitted from a preset position of the game view screen and that points toward the view direction, and in response to the view direction not pointing toward the first objects and the view direction pointing toward the second objects, determining the first of the second objects toward which the view direction points may include:
in response to the first objects not responding to the detection ray and the second objects responding to the detection ray, determining the second object that is the first to respond to the detection ray as the first of the second objects.

For example, when a detection ray is emitted along the line-of-sight origin, and the detection ray does not intersect the first objects, the second object that is the first to respond to the detection ray may be determined as the first of the first objects according to the time sequence of the response of the second objects, thereby improving processing efficiency and facilitating calculation.

In some embodiments, after, in response to a view direction of a game view screen corresponding to the game character pointing toward the virtual interaction object, determining a target virtual prop corresponding to the virtual interaction object from among the at least one candidate virtual prop, the method may further include: displaying the target virtual prop in a first display mode.

The first display mode may be a display mode preset according to specific settings of the game. For example, it may include any one of the following display modes: reducing transparency, increasing color saturation, switching color, highlighting, stroking, adding a highlighting mark, etc. Adding a highlight mark may be adding a mark such as an asterisk, a dot, and a triangle on or near the surface of the target virtual prop.

In some embodiments, the first display mode may be highlight display.

In some embodiments, after, in response to a view direction of a game view screen corresponding to the game character pointing toward the virtual interaction object, determining a target virtual prop corresponding to the virtual interaction object from among the at least one candidate virtual prop, the method may further include: displaying the first bounding box of the target virtual prop in a second display mode.

The second display mode may be a display mode preset according to specific settings of the game. For example, it may include any one of the following display modes: reducing transparency, increasing color saturation, switching color, highlighting, stroking, adding a highlighting mark, etc. The second display mode may be the same as or different from the first display mode. By displaying the target virtual prop or the first bounding box of the target virtual prop in the first display mode or the second display mode, the user may be assisted to quickly find the selected target virtual prop, thereby improving the pickup efficiency of the virtual prop.

In some embodiments, after, in response to a view direction of a game view screen corresponding to the game character pointing toward the virtual interaction object, determining a target virtual prop corresponding to the virtual interaction object from among the at least one candidate virtual prop, the method furthers include:
adjusting the view direction in response to a first view adjustment operation; and
maintaining the target virtual prop as a target virtual prop if the adjusted view direction does not point toward any first object and the adjusted view direction points toward the second object of the target virtual prop.

After the candidate virtual prop is selected by adjusting the view direction of the game view screen, in the case of further adjustment of the view direction of the game view screen, in order to ensure that the adjustment operation is not a wrong operation by the user, a new target virtual prop is determined from among the candidate virtual prop only when the detection ray is adjusted from intersecting the first or second bounding box of the target virtual prop to moving out of the second bounding box of the target virtual prop, or when the adjusted detection ray intersects the first bounding box of another candidate virtual prop. In the adjustment process, when the detection ray moves only within the range of the second bounding box of the target virtual prop, the adjustment operation is regarded as an invalid operation, and a new target virtual prop is not determined, thereby improving the accuracy of picking up the virtual prop.

130. The game character is controlled to pick up the target virtual prop in response to a pickup operation for the target virtual prop.

The pickup operation may refer to an operation for controlling the game character to perform a pickup action for the virtual prop, and the pickup operation may include, but is not limited to, operations such as touch, drag, swipe, long press, short press, double click, click, and drag end. The user can perform the pickup operation through an input device such as a touch screen, a mouse, a keyboard, or a handle, and the specific operation mode depends on the game operation method or specific settings of the game. For example, the user may touch the target virtual prop or a virtual interaction object of the target virtual prop to control the game character to pick up the target virtual prop. Through the pickup operation of the user for the target virtual prop, the candidate virtual prop selected in the view direction of the game view screen in the game scene can be accurately picked up, thereby improving the accuracy of picking up the virtual prop.

In some embodiments, before, in response to a pickup operation for the target virtual prop, controlling the game character to pick up the target virtual prop, the method may further include:
providing a pickup control on the graphical user interface.

In response to a pickup operation for the target virtual prop, controlling the game character to pick up the target virtual prop includes:
in response to a touch operation acting on the pickup control, controlling the game character to pick up the target virtual prop.

A pickup control associated with the target virtual prop may be displayed in the game interface of the graphical user interface. If the user performs a touch operation on the pickup control, the game character may be controlled to automatically pick up the target virtual prop, thereby simplifying the pickup process, achieving quick pickup, and improving the pickup efficiency of the virtual prop.

The solution of picking up a virtual prop provided by the embodiment of the present disclosure may be applied in various game scenes. For example, taking a multiplayer competitive game as an example, at least one candidate virtual prop is determined from among at least one virtual prop in the game scene, the candidate virtual prop being configured with a virtual interaction object; in response to a view direction of a game view screen corresponding to a game character pointing toward the virtual interaction object, a target virtual prop corresponding to the virtual interaction object is determined from among the at least one candidate virtual prop; and in response to a pickup operation for the target virtual prop, the game character is controlled to pick up the target virtual prop.

By means of the virtual interaction object configured for the candidate virtual prop in the solution provided by the embodiments of the present disclosure, an interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

For example, by setting the first object and the second object of the candidate virtual prop, the first object may include a virtual identifier. By displaying the virtual identifier in the game scene, on the one hand, the user may quickly find the candidate virtual prop and the virtual interaction object of the candidate virtual prop, thereby improving the pickup efficiency of the virtual prop. On the other hand, the virtual identifier may be displayed at an easy-to-view height according to the line-of-sight height, thereby improving the pickup efficiency of the virtual prop.

For another example, the first object may include a first bounding box, and the second object may include a second bounding box. On the one hand, an interaction area of the candidate virtual prop is determined using the bounding boxes, where the interaction area is determined by approximately replacing the candidate virtual prop of a complex structure with the simply structured bounding boxes, thereby improving the efficiency of determining the interaction area and simplifying the interaction process to improve the pickup efficiency of the prop. On the other hand, the interaction area of the candidate virtual prop is determined by the first object and the second object, which can provide various means of interaction, to increase the user retention rate and reduce the server waste.

The method according to the above embodiments will be described in further detail below.

In the present embodiment, a method according to an embodiment of the present disclosure will be described in detail using an example in which the game character is in a first-person perspective.

As shown in FIG. 2a, a method for picking up a virtual prop is specifically as follows:

210. Position information of virtual props in a game scene is acquired.

For example, there are three virtual props in the game scene, a virtual prop A, a virtual prop B, and a virtual prop C, and the coordinate positions of the three virtual props in the game scene can be acquired.

220. Pickup areas of the virtual props are generated according to the position information and a preset pickup area condition.

For example, the pickup radius of a virtual prop is set as n m, n=2. As shown in FIG. 2b, spherical pickup areas each having a pickup radius of n m may be determined in the game scene according to the coordinate positions of the virtual prop A, the virtual prop B, and the virtual prop C, respectively, and the areas may each be a spherical bounding box having a radius n. When the game character touches the spherical pickup area, it is considered that the game character is located in an arbitrary pickup area, and the virtual prop is in a pickup-enabled state.

As another example, as shown in FIG. 2c, the distance f between the game character and the virtual prop A may be acquired, and only within the effective pickup distance of 0≤f≤n can the virtual prop stay in the pickup-enabled state. As a result, only within the effective pickup distance can the virtual prop stay in the pickup-enabled state and perform pickup interaction with the view direction of the game view screen. When the effective pickup distance is exceeded, the virtual prop cannot perform pickup interaction with the view direction of the game view screen.

230. If the game character is located within an arbitrary pickup area, the virtual prop corresponding to the arbitrary pickup area is determined as a candidate virtual prop.

For example, the user may control the movement of the game character so that the game character enters the pickup area of at least one virtual prop. As shown in FIG. 2c, the game character enters the pickup area of the virtual prop A, and then the virtual prop A is the candidate virtual prop.

240. A virtual interaction object of the candidate virtual prop is generated.

For example, as shown in FIG. 1c and FIG. 1d, a virtual identifier, a first bounding box and a second bounding box of the virtual prop A may be generated, where, as shown in FIG. 1c and FIG. 1d, the virtual identifier is a virtual light beam extending upward from the midpoint of the candidate virtual prop, and the height thereof is half the height from the ground to the line of sight; the first bounding box is a bounding box on the periphery of the candidate virtual prop and having the same outline as the candidate virtual prop. As shown in FIG. 1d, the second bounding box is a cylindrical bounding box on the periphery of the first bounding box, the cylinder having a height d and a diameter e, where d and e may be set according to the application scenario. At this time, the virtual identifier is visible in the game scene, and the user can quickly find the virtual prop A through the virtual identifier in the game scene. The first bounding box and the second bounding box are not visible in the game scene.

For another example, the height of the virtual light beam may be half the line-of-sight height, so that no pickup interaction occurs when the game character looks straight ahead. When the detection ray of the game character is adjusted slightly downward, the detection ray can intersect the virtual light beam to implement pickup interaction.

250. A detection ray of a game character is adjusted in response to a line-of-sight adjustment operation.

For example, the detection ray may simulate a human eye as a trigger for a pickup interaction. Before adjustment of the detection ray, the view direction thereof may be straight ahead, and at such time, although the user can quickly find the virtual prop A through the virtual identifier in the game scene, the game character cannot interact with the virtual prop A through the view direction since the view direction of the game view screen does not point toward the virtual light beam, the first bounding box, and the second bounding box of the virtual prop A. Therefore, the user can lower the head of the game character through a touch operation on the line-of-sight adjustment control in the game interface until the angle between the detection ray of the game character and the horizontal direction (ground) of the game scene is greater than 0° and less than 45°, that is, as shown in FIG. 1c, the angle b is less than 45°, and in such a view direction, the detection ray of the game character can intersect the virtual light beam.

260. It is determined whether the detection ray points toward the virtual interaction object.

For example, it is determined whether the detection ray intersects the virtual light beam, the first bounding box, or the second bounding box of any candidate virtual prop in the game scene. If so, it is determined whether the detection ray points toward the virtual interaction object.

270. If the detection ray points toward the virtual interaction object, a line-of-sight point of the view direction on the virtual interaction object is determined.

For example, since the virtual light beam does not completely cover the virtual prop A, its main function is to prompt the position of the virtual prop A and interact with the detection ray above the virtual prop A. Since there is always a distance between the game character and the virtual prop A, it is difficult for the detection ray to precisely select the virtual light beam, and the line-of-sight point of the detection ray may be determined according to the virtual light beam, the first bounding box, and the second bounding box.

For example, if the pickup areas of the virtual prop A and the virtual prop B in the game scene overlap, and the game character enters the overlapping area, the virtual prop A and the virtual prop B are both candidate virtual props, and the areas (interaction areas) occupied by different virtual interaction objects in the game scene may be divided into a selection area and a fault tolerance area, and a pickup interaction method may be determined based on the selection area and the fault tolerance area.

For example, if the detection ray intersects the virtual light beam or the first bounding box of the virtual prop A, the virtual prop A is selected as the target virtual prop. Specifically, the interaction area occupied by the second bounding box may be used as the fault tolerance area, and the interaction area occupied by the first bounding box as the selection area. For another example, if there are a plurality of candidate virtual props in the game scene, a plurality of virtual light beams and second bounding boxes may both intersect the detection ray, making mistouch very likely to occur. At this time, the interaction area occupied by the virtual light beam and the second bounding box may be used as the fault tolerance area, and the interaction area occupied by the first bounding box as the selection area. As shown in FIG. 2d, if there are a plurality of candidate virtual props such as a virtual prop A and a virtual prop B, if the detection ray points toward the selection areas of the virtual prop A and the virtual prop B, an intersection A where the selection area of the virtual prop A meets the detection ray and an intersection B where the selection area of the virtual prop B meets the detection ray may be obtained as the line-of-sight points.

280. A target virtual prop is determined from among the candidate virtual prop according to the line-of-sight point.

For example, the coordinate positions of the intersection A and the intersection B in the game scene, and the coordinate position of the game character in the game scene may be acquired, the intersection A closest to the line-of-sight origin of the game character is determined as a target intersection with which the detection ray first comes into contact, and the virtual prop A corresponding to the intersection A is determined as the target virtual prop (i.e., the candidate virtual prop with which the detection ray first comes into contact). After the prop to be picked up is determined, the target virtual prop may be highlighted by stroking or, as shown in FIG. 2e, a description interface for the target virtual prop is displayed on the game interface.

As shown in the process of FIG. 2f, the pickup area of each virtual prop in the game scene is determined, and the pickup area may be a spherical bounding box. If the game character is within the pickup range of the virtual prop A and the virtual prop B at the same time, the virtual identifier, the first bounding box, and the second bounding box of the virtual prop A and the virtual prop B are generated, respectively. If the game character is not within the pickup range of the virtual prop A and the virtual prop B, the virtual prop A and the virtual prop B do not respond to the pickup interaction. If the detection ray first intersects the selection area of the virtual prop A, the virtual prop A is selected. After the user adjusts the detection ray, if the detection ray first intersects the selection area of the virtual prop B, the virtual prop B is selected. After the user adjusts the detection ray, if the detection ray does not intersect the selection area of the virtual prop B, but intersects the fault tolerance area of the virtual prop A, the selection of the virtual prop A is maintained. After the user adjusts the detection ray, if the detection ray does not intersect the selection area of the virtual prop B or the fault tolerance area of the virtual prop A, but intersects the fault tolerance area of the virtual prop B, the virtual prop B is selected. If the detection ray does not intersect the selection area or fault tolerance area of any candidate virtual prop, then no candidate virtual prop is selected. The selected virtual prop A or virtual prop B may be picked up in response to the pickup operation, while the virtual prop A or virtual prop B not selected does not respond to the pickup operation. In this way, when a virtual prop is selected, the selected state is maintained as long as the detection ray intersects the fault tolerance area of the virtual prop but does not intersect the selection area of other virtual props. Thus, the virtual prop can be prevented from getting out of the selected state due to a movement caused by mistouch, and if there is only one candidate virtual prop, the fault tolerance area can help the user quickly select the only candidate virtual prop.

In this way, by providing the spherical bounding box, the first bounding box (the selection area), and the second bounding box (the fault tolerance area), the virtual prop is surrounded by three bounding boxes. The three surrounding boxes can respond to different interaction processes, and cooperate with each other to improve the accuracy and efficiency of picking up the virtual prop.

290. The game character is controlled to pick up the target virtual prop in response to a pickup operation for the target virtual prop.

For example, the game character is controlled to pick up the target virtual prop in response to a touch operation acting on the pickup control by the user.

As can be seen from the above, the embodiment of the present disclosure provides two layers of pickup determination ranges for each virtual prop by setting a selection area and a fault tolerance area, where the selection area is used for precise switching, and the fault tolerance area for fault tolerance of selection. When picking up a virtual prop, if there are a plurality of virtual props that are too close to each other or overlap with each other, the selected virtual prop can be precisely switched by means of the selection area, thereby improving the accuracy and efficiency of picking up the virtual prop. By means of the fault tolerance area, the interaction area of the selected virtual prop is expanded, increasing the fault tolerance. When the user adjusts the detection ray, a smooth pickup experience is provided.

In order to better implement the above method, the embodiments of the present disclosure further provide an apparatus for picking up a virtual prop, wherein the apparatus for picking up a virtual prop may be integrated in an electronic device, and the electronic device may be a terminal, a server, or the like. The terminal may be a device such as a mobile phone, a tablet computer, a smart Bluetooth device, a notebook computer, or a personal computer. The server may be a single server or a server cluster composed of a plurality of servers.

For example, in the present embodiment, a method according to an embodiment of the present disclosure will be described in detail by using an example in which an apparatus for picking up a virtual prop is integrated in a terminal. A graphical user interface is provided by the terminal, the content displayed on the graphical user interface at least partially includes a game scene, and a game character and at least one virtual prop located in the game scene.

For example, as shown in FIG. 3, the apparatus for picking up a virtual prop may include a generation unit 310, a determination unit 320, and a pickup unit 330, as follows:

### (I) Generation Unit 310

At least one candidate virtual prop is determined from among the at least one virtual prop in the game scene, the candidate virtual prop being configured with a virtual interaction object.

In some embodiments, the generation unit 310 may be specifically used for: acquiring prop position information of a virtual prop in the game scene; generating a pickup area of the virtual prop according to the prop position information and a preset pickup area condition; and if the game character is located within an arbitrary pickup area, determining at least one virtual prop corresponding to the arbitrary pickup area as a candidate virtual prop.

In some embodiments, the preset pickup area condition includes a pickup radius, and generating a pickup area of the virtual prop according to the prop position information and a preset pickup area condition includes: generating an initial pickup area according to the prop position information and the pickup radius; and adjusting the initial pickup area according to the number of game characters in the initial pickup area, to obtain a pickup area of the virtual prop.

In some embodiments, a first object may include a virtual identifier, and the generation unit 310 may be further used for: acquiring a line-of-sight height of a game view screen; determining a display height of the virtual identifier of the candidate virtual prop according to the line-of-sight height; and displaying the virtual identifier of the candidate virtual prop at the display height.

In some embodiments, determining a display height of the virtual identifier of the candidate virtual prop according to the line-of-sight height includes: acquiring a preset weight parameter; and performing weight calculation on the line-of-sight height according to the preset weight parameter, to obtain a display height of the virtual identifier of the candidate virtual prop.

In some embodiments, the first object may include a first bounding box, and a second object may include a second bounding box, the first bounding box being located within the second bounding box.

### (II) Determination Unit 320

In response to a view direction of the game view screen corresponding to the game character pointing toward the virtual interaction object, a target virtual prop corresponding to the virtual interaction object is determined from among the at least one candidate virtual prop.

In some embodiments, the virtual interaction object may include at least one of the first object and the second object, and the determination unit 320 may be specifically used for: in response to the view direction of the game view screen corresponding to the game character pointing toward the first object or the second object, determining the target virtual prop corresponding to the virtual interaction object from among the at least one candidate virtual prop.

In some embodiments, in response to the view direction of the game view screen corresponding to the game character pointing toward the first object or the second object, determining the target virtual prop corresponding to the virtual interaction object from among the at least one candidate virtual prop may include: in response to the view direction of the game view screen corresponding to the game character pointing toward the first object, determining a target virtual prop corresponding to the first object from among the at least one candidate virtual prop; or in response to the view direction not pointing toward the first object and the view direction pointing toward the second object, determining a target virtual prop corresponding to the second object from among the at least one candidate virtual prop.

In some embodiments, in response to the view direction of the game view screen corresponding to the game character pointing toward the first object, determining a target virtual prop corresponding to the first object from among the at least one candidate virtual prop includes: in response to a view direction of a game view screen corresponding to the game character pointing toward the first objects, determining the first of the first objects toward which the view direction points; and determining a target virtual prop corresponding to the first of the first objects from among the at least one candidate virtual prop.

In some embodiments, the view direction includes a detection ray that is emitted from a preset position of the game view screen and that points toward the view direction, and in response to a view direction of a game view screen corresponding to the game character pointing toward the first object, determining the first of the first objects toward which the view direction points, includes: determining a first intersection in response to the detection ray pointing toward at least one of the first objects, the first intersection being an intersection between the detection ray and the first object; and according to position information of the first intersection, determining, from among the first objects, the first of the first objects toward which the view direction points.

In some embodiments, in response to the view direction not pointing toward the first object and the view direction pointing toward the second object, determining a target virtual prop corresponding to the second object from among the at least one candidate virtual prop includes: in response to the view direction not pointing toward the first objects and the view direction pointing toward the second objects, determining the first of the second objects toward which the view direction points; and determining a target virtual prop corresponding to the first of the second objects from among the at least one candidate virtual prop.

In some embodiments, the view direction includes a detection ray that is emitted from a preset position of the game view screen and that points toward the view direction, and in response to the view direction not pointing toward the first objects and the view direction pointing toward the second objects, determining the first of the second objects toward which the view direction points includes: determining second intersections in response to the detection ray not pointing toward the first objects and the detection ray pointing toward the second objects, the second intersections being intersections between the detection ray and the second objects; and according to the position information of the second intersections, determining, from among the second objects, the first of the second objects toward which the view direction points.

In some embodiments, the determination unit 320 may be further used for: adjusting the view direction in response to a first view adjustment operation; and maintaining the target virtual prop as a target virtual prop if the adjusted view direction does not point toward any first object and the adjusted view direction points toward the second object of the target virtual prop.

In some embodiments, the determination unit 320 may be further used for: displaying the target virtual prop in a first display mode.

In some embodiments, the determination unit 320 may be further used for: adjusting the view direction in response to a second view adjustment operation.

In some embodiments, the determination unit 320 may be further used for: displaying the first bounding box of the target virtual prop in a second display mode.

### (III) Pickup Unit 330

In response to a pickup operation for the target virtual prop, the game character is controlled to pick up the target virtual prop.

In some embodiments, the pickup unit 330 may be specifically used for: providing a pickup control on the graphical user interface.

In response to a pickup operation for the target virtual prop, controlling the game character to pick up the target virtual prop includes: in response to a touch operation acting on the pickup control, controlling the game character to pick up the target virtual prop.

During specific implementation, each unit above may be implemented as an independent entity, or may be implemented as the same or several entities in any combination. For specific implementation of each unit above, reference may be made to foregoing embodiments of the method, and details are not described herein again.

Thus, in the embodiments of the present disclosure, by means of the virtual interaction object configured for the candidate virtual prop, an interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

Accordingly, an embodiment of the present disclosure further provides a computer device, wherein the computer device may be a terminal or a server, and the terminal may be a terminal device such as a smart phone, a tablet computer, a notebook computer, a touch screen, a game machine, a personal computer, and a PDA (personal digital assistant).

FIG. 4 shows a schematic structural diagram of a computer device according to an embodiment of the present disclosure, wherein the computer device 400 includes a processor 410 having one or more processing cores, a memory 420 having one or more computer-readable storage media, and a computer program stored in the memory 420 and executable on the processor. The processor 410 is electrically connected to the memory 420. Those skilled in the art can understand that the structure of the computer device shown in the drawing does not constitute a limitation of the computer device, and same may include more or fewer components than those shown in the drawing, or a combination of some components, or different component arrangements.

The processor 410 is a control center of the computer device 400, connects various parts of the entire computer device 400 using various interfaces and lines, performs various functions of the computer device 400 and processes data by executing or loading software programs and/or modules stored in the memory 420 and calling data stored in the memory 420, to perform overall monitoring of the computer device 400.

In the embodiment of the present disclosure, the processor 410 in the computer device 400 follows the steps below to load instructions corresponding to one or more application programs into the memory 420, and the processor 410 executes the application programs stored in the memory 420, to implement the method described in the foregoing embodiments:
determining at least one candidate virtual prop from among at least one virtual prop in a game scene, the candidate virtual prop being configured with a virtual interaction object; in response to a view direction of a game view screen corresponding to a game character pointing toward the virtual interaction object, determining a target virtual prop corresponding to the virtual interaction object from among the at least one candidate virtual prop; and in response to a pickup operation for the target virtual prop, controlling the game character to pick up the target virtual prop.

In some embodiments, the virtual interaction object may include at least one of a first object and a second object, and in response to a view direction of a game view screen corresponding to a game character pointing toward the virtual interaction object, determining a target virtual prop corresponding to the virtual interaction object from among the at least one candidate virtual prop may include: in response to a view direction of a game view screen corresponding to the game character pointing toward the first object or the second object, determining a target virtual prop corresponding to the virtual interaction object from among the at least one candidate virtual prop.

In some embodiments, the first object may include a virtual identifier, and before, in response to a view direction of a game view screen corresponding to a game character pointing toward the virtual interaction object, determining a target virtual prop corresponding to the virtual interaction object from among the at least one candidate virtual prop, the method may further include: acquiring a line-of-sight height of the game view screen; determining a display height of the virtual identifier of the candidate virtual prop according to the line-of-sight height; and displaying the virtual identifier of the candidate virtual prop at the display height.

In some embodiments, determining a display height of the virtual identifier of the candidate virtual prop according to the line-of-sight height may include: acquiring a preset weight parameter; and performing weight calculation on the line-of-sight height according to the preset weight parameter, to obtain a display height of the virtual identifier of the candidate virtual prop.

In some embodiments, the first object may include a first bounding box, and the second object may include a second bounding box, the first bounding box being located within the second bounding box.

In some embodiments, after, in response to a view direction of a game view screen corresponding to a game character pointing toward the virtual interaction object, determining a target virtual prop corresponding to the virtual interaction object from among the at least one candidate virtual prop, the method may further include: displaying the first bounding box of the target virtual prop in a second display mode.

In some embodiments, in response to the view direction of the game view screen corresponding to the game character pointing toward the first object or the second object, determining a target virtual prop corresponding to the virtual interaction object from among the at least one candidate virtual prop may include: in response to the view direction of the game view screen corresponding to the game character pointing toward the first object, determining a target virtual prop corresponding to the first object from among the at least one candidate virtual prop; or in response to the view direction not pointing toward the first object and the view direction pointing toward the second object, determining a target virtual prop corresponding to the second object from among the at least one candidate virtual prop.

In some embodiments, in response to the view direction of the game view screen corresponding to the game character pointing toward the first object, determining a target virtual prop corresponding to the first object from among the at least one candidate virtual prop may include: in response to the view direction of the game view screen corresponding to the game character pointing toward the first objects, determining the first of the first objects toward which the view direction points; and determining a target virtual prop corresponding to the first of the first objects from among the at least one candidate virtual prop.

In some embodiments, the view direction may include a detection ray that is emitted from a preset position of the game view screen and that points toward the view direction, and, in response to the view direction of the game view screen corresponding to the game character pointing toward the first objects, determining the first of the first objects toward which the view direction points may include: determining a first intersection in response to the detection ray pointing toward at least one of the first objects, the first intersection being an intersection between the detection ray and the first object; and according to position information of the first intersection, determining, from among the first objects, the first of the first objects toward which the view direction points.

In some embodiments, in response to the view direction not pointing toward the first object and the view direction pointing toward the second object, determining a target virtual prop corresponding to the second object from among the at least one candidate virtual prop may include: in response to the view direction not pointing toward the first objects and the view direction pointing toward the second objects, determining the first of the second objects toward which the view direction points; and determining a target virtual prop corresponding to the first of the second objects from among the at least one candidate virtual prop.

In some embodiments, the view direction may include a detection ray that is emitted from a preset position of the game view screen and that points toward the view direction, and in response to the view direction not pointing toward the first objects and the view direction pointing toward the second objects, determining the first of the second objects toward which the view direction points may include: determining second intersections in response to the detection ray not pointing toward the first objects and the detection ray pointing toward the second objects, the second intersections being intersections between the detection ray and the second objects; and according to position information of the second intersections, determining, from among the second objects, the first of the second objects toward which the view direction points.

In some embodiments, after, in response to a view direction of a game view screen corresponding to a game character pointing toward the virtual interaction object, determining a target virtual prop corresponding to the virtual interaction object from among the at least one candidate virtual prop, the method may further include: adjusting the view direction in response to a first view adjustment operation; and maintaining the target virtual prop as a target virtual prop if the adjusted view direction does not point toward any first object and the adjusted view direction points toward the second object of the target virtual prop.

In some embodiments, after, in response to a view direction of a game view screen corresponding to a game character pointing toward the virtual interaction object, determining a target virtual prop corresponding to the virtual interaction object from among the at least one candidate virtual prop, the method may further include: displaying the target virtual prop in a first display mode.

In some embodiments, determining at least one candidate virtual prop from among at least one virtual prop in a game scene may include: acquiring prop position information of the virtual prop in the game scene; generating a pickup area of the virtual prop according to the prop position information and a preset pickup area condition; and if the game character is located within an arbitrary pickup area, determining at least one virtual prop corresponding to the arbitrary pickup area as a candidate virtual prop.

In some embodiments, the preset pickup area condition includes a pickup radius, and generating a pickup area of the virtual prop according to the prop position information and the preset pickup area condition may include: generating an initial pickup area according to the prop position information and the pickup radius; and adjusting the initial pickup area according to the number of game characters in the initial pickup area, to obtain a pickup area of the virtual prop.

In some embodiments, before, in response to a view direction of a game view screen corresponding to a game character pointing toward the virtual interaction object, determining a target virtual prop corresponding to the virtual interaction object from among the at least one candidate virtual prop, the method may further include: adjusting the view direction in response to a second view adjustment operation.

In some embodiments, before, in response to a pickup operation for the target virtual prop, controlling the game character to pick up the target virtual prop, the method may further include: providing a pickup control on a graphical user interface.

In response to a pickup operation for the target virtual prop, controlling the game character to pick up the target virtual prop includes: in response to a touch operation acting on the pickup control, controlling the game character to pick up the target virtual prop.

The content of the specific embodiment of the method for picking up a virtual prop according to the present embodiment is also applicable to the content of the above-mentioned embodiment of the method for picking up a virtual prop, so the details are not described herein.

In the method for picking up a virtual prop according to an embodiment of the present disclosure, by means of the virtual interaction object configured for the candidate virtual prop, an interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

In some examples, as shown in FIG. 4, the computer device 400 further includes: a touch display screen 430, a radio-frequency circuit 440, an audio-frequency circuit 450, an input unit 460, and a power supply 470. The processor 410 is electrically connected to the touch display screen 430, the radio-frequency circuit 440, the audio-frequency circuit 450, the input unit 460, and the power supply 470. Those skilled in the art can understand that the structure of the computer device shown in the FIG. 4 does not constitute a limitation of the computer device, and same may include more or fewer components than those shown in the drawing, or a combination of some components, or different component arrangements.

The touch display screen 430 may be used to display a graphical user interface and receive operation instructions generated by a user acting on the graphical user interface. The touch display screen 430 may include a display panel and a touch panel. The display panel may be used to display information entered by or provided to the user as well as various graphical user interfaces of the computer device, which may be comprised of graphics, text, icons, videos, and any combination thereof. In some examples, the display panel may be configured in the form of LCD (liquid crystal display), OLED (organic light-emitting diode), or the like. The touch panel may be used to collect a touch operation on or near the user (e.g., an operation on or near the touch panel by the user using any suitable object or accessory such as a finger, a stylus pen, etc.), and to generate a corresponding operation instruction, wherein the operation instruction executes a corresponding program. In some examples, the touch panel may include two parts, a touch detector and a touch controller. The touch detector detects a touch orientation of the user, detects a signal triggered by the touch operation, and transmits the signal to the touch controller. The touch controller receives the touch information from the touch detector, converts the touch information into contact coordinates, and sends the contact coordinates to the processor 410, and can receive and execute commands from the processor 410. The touch panel may cover the display panel. When the touch panel detects a touch operation on or near the touch panel, the touch panel transmits the touch operation to the processor 410 to determine the type of the touch event. Then the processor 410 provides corresponding visual output on the display panel according to the type of the touch event. In the embodiment of the present disclosure, input and output functions may be implemented by integrating the touch panel and the display panel into the touch display screen 430. In some embodiments, however, the touch panel and the display panel may serve as two independent components to implement the input and output functions. That is, the touch display screen 430 may also serve as part of the input unit 460 to implement the input function.

In the embodiment of the present disclosure, the graphical user interface is generated on the touch display screen 430 by the processor 410 executing a game application, and the content displayed on the graphical user interface includes, at least in part, a game scene, and a game character and at least one virtual prop located in the game scene. The touch display screen 430 is used to display the graphical user interface and receive operation instructions generated by the user acting on the graphical user interface.

The radio-frequency circuit 440 may be used to transmit and receive radio-frequency signals, to establish wireless communication with network devices or other computer devices via wireless communication, and to transmit and receive signals to and from the network devices or other computer devices.

The audio-frequency circuit 450 may be used to provide an audio interface between the user and the computer device through a speaker and a microphone. The audio-frequency circuit 450 may transmit an electrical signal obtained by converting the received audio data to the speaker which converts the electrical signal into a sound signal to be outputted. On the other hand, the microphone converts the collected sound signal into an electrical signal, which is received by the audio-frequency circuit 450 and then converted into audio data. The audio data is outputted to the processor 410 for processing, and then transmitted to, for example, another computer device via the radio-frequency circuit 440, or the audio data is outputted to the memory 420 for further processing. The audio-frequency circuit 450 may also include an earphone jack to provide communication between an external earphone and the computer device.

The input unit 460 may be used to receive inputted numbers, character information, or user characteristic information (e.g., fingerprint, iris, facial information, etc.), and to generate keyboard, mouse, joystick, optical, or trackball signal input related to user settings and function control.

The power supply 470 is used to power various components of the computer device 400. In some examples, the power supply 470 may be logically connected to the processor 410 through a power management system, to implement functions such as management of charging, discharging, and power consumption through the power management system. The power supply 470 may further include one or more arbitrary components such as a DC or AC power supply, a recharging system, a power failure detection circuit, a power converter or inverter, and a power status indicator.

Although not shown in FIG. 4, the computer device 400 may further include a camera, a sensor, a wireless fidelity module, a Bluetooth module, and the like, which are not described in detail herein.

Each of the above embodiments is described with emphasis. For parts not described in detail in a certain embodiment, reference may be made to related descriptions of other embodiments.

It can be seen from the above that, in the computer device provided by the present embodiment, by means of the virtual interaction object configured for the candidate virtual prop, the interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

Those of ordinary skill in the art will appreciate that all or part of the steps in the various methods of the above embodiments may be implemented by instructions, or by instructions controlling related hardware, and the instructions may be stored in a computer-readable storage medium and loaded and executed by a processor.

To this end, an embodiment of the present disclosure provides a computer-readable storage medium, in which a plurality of computer programs are stored, wherein the computer program can be loaded by a processor to perform the steps of any one of the methods for picking up a virtual prop provided by the embodiments of the present disclosure. For example, the computer program may perform the steps of the methods of the foregoing embodiments:
determining at least one candidate virtual prop from among at least one virtual prop in a game scene, the candidate virtual prop being configured with a virtual interaction object; in response to a view direction of a game view screen corresponding to a game character pointing toward the virtual interaction object, determining a target virtual prop corresponding to the virtual interaction object from among the at least one candidate virtual prop; and in response to a pickup operation for the target virtual prop, controlling the game character to pick up the target virtual prop.

In some embodiments, the virtual interaction object may include at least one of a first object and a second object, and in response to a view direction of a game view screen corresponding to a game character pointing toward the virtual interaction object, determining a target virtual prop corresponding to the virtual interaction object from among the at least one candidate virtual prop may include: in response to a view direction of a game view screen corresponding to the game character pointing toward the first object or the second object, determining a target virtual prop corresponding to the virtual interaction object from among the at least one candidate virtual prop.

In some embodiments, the first object may include a virtual identifier, and before, in response to a view direction of a game view screen corresponding to a game character pointing toward the virtual interaction object, determining a target virtual prop corresponding to the virtual interaction object from among the at least one candidate virtual prop, the method may further include: acquiring a line-of-sight height of the game view screen; determining a display height of the virtual identifier of the candidate virtual prop according to the line-of-sight height; and displaying the virtual identifier of the candidate virtual prop at the display height.

In some embodiments, determining a display height of the virtual identifier of the candidate virtual prop according to the line-of-sight height may include: acquiring a preset weight parameter; and performing weight calculation on the line-of-sight height according to the preset weight parameter, to obtain a display height of the virtual identifier of the candidate virtual prop.

In some embodiments, the first object may include a first bounding box, and the second object may include a second bounding box, the first bounding box being located within the second bounding box.

In some embodiments, after, in response to a view direction of a game view screen corresponding to a game character pointing toward the virtual interaction object, determining a target virtual prop corresponding to the virtual interaction object from among the at least one candidate virtual prop, the method may further include: displaying the first bounding box of the target virtual prop in a second display mode.

In some embodiments, in response to the view direction of the game view screen corresponding to the game character pointing toward the first object or the second object, determining a target virtual prop corresponding to the virtual interaction object from among the at least one candidate virtual prop may include: in response to the view direction of the game view screen corresponding to the game character pointing toward the first object, determining a target virtual prop corresponding to the first object from among the at least one candidate virtual prop; or in response to the view direction not pointing toward the first object and the view direction pointing toward the second object, determining a target virtual prop corresponding to the second object from among the at least one candidate virtual prop.

In some embodiments, in response to the view direction of the game view screen corresponding to the game character pointing toward the first object, determining a target virtual prop corresponding to the first object from among the at least one candidate virtual prop may include: in response to the view direction of the game view screen corresponding to the game character pointing toward the first objects, determining the first of the first objects toward which the view direction points; and determining a target virtual prop corresponding to the first of the first objects from among the at least one candidate virtual prop.

In some embodiments, the view direction may include a detection ray that is emitted from a preset position of the game view screen and that points toward the view direction, and in response to the view direction of the game view screen corresponding to the game character pointing toward the first objects, determining the first of the first objects toward which the view direction points may include: determining a first intersection in response to the detection ray pointing toward at least one of the first objects, the first intersection being an intersection between the detection ray and the first object; and according to position information of the first intersection, determining, from among the first objects, the first of the first objects toward which the view direction points.

In some embodiments, in response to the view direction not pointing toward the first object and the view direction pointing toward the second object, determining a target virtual prop corresponding to the second object from among the at least one candidate virtual prop, may include: in response to the view direction not pointing toward the first objects and the view direction pointing toward the second objects, determining the first of the second objects toward which the view direction points; and determining a target virtual prop corresponding to the first of the second objects from among the at least one candidate virtual prop.

In some embodiments, the view direction may include a detection ray that is emitted from a preset position of the game view screen and that points toward the view direction, and in response to the view direction not pointing toward the first objects and the view direction pointing toward the second objects, determining the first of the second objects toward which the view direction points, may include: determining second intersections in response to the detection ray not pointing toward the first objects and the detection ray pointing toward the second objects, the second intersections being intersections between the detection ray and the second objects; and according to position information of the second intersections, determining, from among the second objects, the first of the second objects toward which the view direction points.

In some embodiments, after, in response to a view direction of a game view screen corresponding to a game character pointing toward the virtual interaction object, determining a target virtual prop corresponding to the virtual interaction object from among the at least one candidate virtual prop, the method may further include: adjusting the view direction in response to a first view adjustment operation; and maintaining the target virtual prop as a target virtual prop if the adjusted view direction does not point toward any first object and the adjusted view direction points toward the second object of the target virtual prop.

In some embodiments, after, in response to a view direction of a game view screen corresponding to a game character pointing toward the virtual interaction object, determining a target virtual prop corresponding to the virtual interaction object from among the at least one candidate virtual prop, the method may further include: displaying the target virtual prop in a first display mode.

In some embodiments, determining at least one candidate virtual prop from among at least one virtual prop in a game scene may include: acquiring prop position information of the virtual prop in the game scene; generating a pickup area of the virtual prop according to the prop position information and a preset pickup area condition; and if the game character is located within an arbitrary pickup area, determining at least one virtual prop corresponding to the arbitrary pickup area as a candidate virtual prop.

In some embodiments, the preset pickup area condition includes a pickup radius, and generating a pickup area of the virtual prop according to the prop position information and the preset pickup area condition may include: generating an initial pickup area according to the prop position information and the pickup radius; and adjusting the initial pickup area according to the number of game characters in the initial pickup area, to obtain a pickup area of the virtual prop.

In some embodiments, before, in response to a view direction of a game view screen corresponding to a game character pointing toward the virtual interaction object, determining a target virtual prop corresponding to the virtual interaction object from among the at least one candidate virtual prop, the method may further include: adjusting the view direction in response to a second view adjustment operation.

In some embodiments, before, in response to a pickup operation for the target virtual prop, controlling the game character to pick up the target virtual prop, the method may further include: providing a pickup control on the graphical user interface.

In response to a pickup operation for the target virtual prop, controlling the game character to pick up the target virtual prop includes: in response to a touch operation acting on the pickup control, controlling the game character to pick up the target virtual prop.

The content of the specific embodiment of the method for picking up a virtual prop according to the present embodiment is also applicable to the content of the above-mentioned embodiment of the method for picking up a virtual prop, so the details are not described herein.

In the method for picking up a virtual prop according to an embodiment of the present disclosure, by means of the virtual interaction object configured for the candidate virtual prop, an interaction area of the candidate virtual prop in the game scene may be determined using the virtual interaction object, to determine the target virtual prop from among the candidate virtual prop according to the result of interaction between the view direction and the virtual interaction object, thereby increasing the precision of selecting any candidate virtual prop, to improve the accuracy of picking up the virtual prop. In addition, through interaction between the view direction and the virtual interaction object, the user may be assisted in quickly deciding on the virtual prop to be picked up, thereby simplifying the pickup process, achieving quick pickup, and improving the pickup efficiency of the virtual prop.

The storage medium may include: a ROM (read only memory), a RAM (random access memory), a magnetic disk, or an optical disk, etc.

Since the computer program stored in the storage medium may execute the steps of any method for picking up a virtual prop provided by the embodiments of the present disclosure, the advantageous effects that can be achieved by any method for picking up a virtual prop provided by the embodiments of the present disclosure can be achieved, which are described in detail in the foregoing embodiments, and will not be described herein again.

The method and apparatus for picking up a virtual prop, the computer device, and the storage medium provided by the embodiments of the present disclosure have been described in detail above, and specific examples are applied herein to illustrate the principles and implementation manners of the present disclosure, and the descriptions of the above embodiments are only used to help understand the method of the present disclosure and the core idea thereof. Meanwhile, for a person skilled in the art, variations may be made to the specific embodiments and application range based on the idea of the present disclosure. In conclusion, the content of the present description should not be construed as limiting the present disclosure.

1. A method for picking up a virtual prop:
determining at least one candidate virtual prop from among one or more virtual props in a game scene, the at least one candidate virtual prop being configured with a virtual interaction object, wherein the game scene, the one or more virtual props and a game character are displayed on a graphical user interface of a terminal;
in response to a view direction of a game view screen corresponding to the game character pointing toward the virtual interaction object, determining a target virtual prop corresponding to the virtual interaction object from among the at least one candidate virtual prop; and
in response to a pickup operation for the target virtual prop, controlling the game character to pick up the target virtual prop.

2. The method for picking up a virtual prop according to claim 1, wherein the virtual interaction object comprises a first object and a second object, and wherein the first object comprises a first bounding box, the second object comprises a second bounding box, and the first bounding box is located inside the second bounding box.

3. The method for picking up a virtual prop according to claim 1, wherein the virtual interaction object comprises a virtual identifier, and wherein, before determining the target virtual prop corresponding to the virtual interaction object from among the at least one candidate virtual prop, the method further comprises:
acquiring a line-of-sight height of the game view screen;
determining a display height of the virtual identifier of the at least one candidate virtual prop according to the line-of-sight height; and
displaying the virtual identifier of the at least one candidate virtual prop at the display height.

4. The method for picking up a virtual prop according to claim 3, wherein determining the display height of the virtual identifier of the at least one candidate virtual prop according to the line-of-sight height comprises:
acquiring a preset weight parameter; and
performing weight calculation on the line-of-sight height according to the preset weight parameter, to obtain the display height of the virtual identifier of the at least one candidate virtual prop.

5. (canceled)

6. The method for picking up a virtual prop according to claim 2, wherein after determining the target virtual prop corresponding to the virtual interaction object from among the at least one candidate virtual prop, the method further comprises:
displaying the first bounding box of the target virtual prop in a second display mode.

7. The method for picking up a virtual prop according to claim 2, wherein determining the target virtual prop corresponding to the virtual interaction object from among the at least one candidate virtual prop comprises:
in response to the view direction of the game view screen corresponding to the game character pointing toward the first object, determining the target virtual prop corresponding to the first object from among the at least one candidate virtual prop; or
of in response to the view direction not pointing toward the first object and the view direction pointing toward the second object, determining the target virtual prop corresponding to the second object from among the at least one candidate virtual prop.

8. The method for picking up a virtual prop according to claim 7, wherein determining the target virtual prop corresponding to the first object from among the at least one candidate virtual prop comprises:
in response to the view direction of the game view screen corresponding to the game character pointing toward the first object, determining a first of the first object toward which the view direction points; and
determining the target virtual prop corresponding to the first of the first object from among the at least one candidate virtual prop.

9. The method for picking up a virtual prop according to claim 8, wherein the view direction comprises a detection ray emitted from a preset position of the game view screen and pointing toward the view direction, and wherein determining the first of the first objects toward which the view direction points comprises:
determining a first intersection in response to the detection ray pointing toward the first object, the first intersection being an intersection between the detection ray and the first object; and
according to position information of the first intersection, determining, from among the first object, the first of the first object toward which the view direction points.

10. The method for picking up a virtual prop according to claim 7, wherein determining the target virtual prop corresponding to the second object from among the at least one candidate virtual prop comprises:
in response to the view direction not pointing toward the first object and the view direction pointing toward the second object, determining a first of the second object toward which the view direction points; and
determining the target virtual prop corresponding to the first of the second object from among the at least one candidate virtual prop.

11. The method for picking up a virtual prop according to claim 10, wherein the view direction comprises a detection ray emitted from a preset position in the game view screen and pointing toward the view direction, and wherein determining the first of the second object toward which the view direction points comprises:
determining second intersections in response to the detection ray not pointing toward the first object and the detection ray pointing toward the second object, the second intersection being an intersection between the detection ray and the second object; and
according to position information of the second intersection, determining, from among the second object, the first of the second object toward which the view direction points.

12. The method for picking up a virtual prop according to claim 2, wherein after determining the target virtual prop corresponding to the virtual interaction object from among the at least one candidate virtual prop, the method further comprises:
adjusting the view direction in response to a first view adjustment operation; and
maintaining the target virtual prop if the adjusted view direction does not point toward the first object and the adjusted view direction points toward the second object of the target virtual prop.

13. The method for picking up a virtual prop according to claim 1, wherein after determining the target virtual prop corresponding to the virtual interaction object from among the at least one candidate virtual prop, the method further comprises:
displaying the target virtual prop in a first display mode.

14. The method for picking up a virtual prop according to claim 1, wherein the determining the at least one candidate virtual prop from among the one or more virtual props in the game scene comprises:
acquiring prop position information of the virtual prop in the game scene;
generating a pickup area of the virtual prop according to the prop position information and a preset pickup area condition; and
determining the one or more virtual props corresponding to an arbitrary pickup area as the at least one candidate virtual prop if the game character is located in the arbitrary pickup area.

15. The method for picking up a virtual prop according to claim 14, wherein the preset pickup area condition comprises a pickup radius, and generating the pickup area of the virtual prop according to the prop position information and the preset pickup area condition comprises:
generating an initial pickup area according to the prop position information and the pickup radius; and
adjusting the initial pickup area according to a number of game characters in the initial pickup area, to obtain the pickup area of the virtual prop.

16. The method for picking up a virtual prop according to claim 1, wherein before determining the target virtual prop corresponding to the virtual interaction object from among the at least one candidate virtual prop, the method further comprises:
adjusting the view direction in response to a second view adjustment operation.

17. The method for picking up a virtual prop according to claim 1, wherein before controlling the game character to pick up the target virtual prop, the method further comprises:
providing a pickup control on the graphical user interface; and
in response to the pickup operation for the target virtual prop, controlling the game character to pick up the target virtual prop, comprising:
in response to a touch operation acting on the pickup control, controlling the game character to pick up the target virtual prop.

18-19. (canceled)

20. A non-transitory computer-readable storage medium, storing a plurality of instructions adapted to be loaded by one or more processors collectively or individually, to perform operations, the operations comprising:
determining at least one candidate virtual prop from among one or more virtual props in a game scene, the at least one candidate virtual prop being configured with a virtual interaction object, wherein the game scene, the one or more virtual props and a game character are displayed on a graphical user interface of a terminal;
in response to a view direction of a game view screen corresponding to the game character pointing toward the virtual interaction object, determining a target virtual prop corresponding to the virtual interaction object from among the at least one candidate virtual prop; and
in response to a pickup operation for the target virtual prop, controlling the game character to pick up the target virtual prop.

21. A system, comprising:
one or more processors;
one or more memories storing computer-executable instructions, which, when executed on any combination of the one or more processors, performs operations, the operations comprising:
determining at least one candidate virtual prop from among one or more virtual props in a game scene, the at least one candidate virtual prop being configured with a virtual interaction object, wherein the game scene, the one or more virtual props and a game character are displayed on a graphical user interface of a terminal;
in response to a view direction of a game view screen corresponding to the game character pointing toward the virtual interaction object, determining a target virtual prop corresponding to the virtual interaction object from among the at least one candidate virtual prop; and
in response to a pickup operation for the target virtual prop, controlling the game character to pick up the target virtual prop.

22. The system of claim 21, wherein the virtual interaction object comprises a virtual identifier, and
wherein, before determining the target virtual prop corresponding to the virtual interaction object from among the at least one candidate virtual prop, the computer-executable instructions, which, when executed on any combination of the one or more processors, performs the operations further comprising:
acquiring a line-of-sight height of the game view screen, comprising acquiring a preset weight parameter;
determining a display height of the virtual identifier of the at least one candidate virtual prop according to the line-of-sight height, comprising performing weight calculation on the line-of-sight height according to the preset weight parameter, to obtain the display height of the virtual identifier of the at least one candidate virtual prop; and
displaying the virtual identifier of the at least one candidate virtual prop at the display height.

23. The system of claim 21, wherein the view direction comprises a detection ray emitted from a preset position of the game view screen and pointing toward the view direction, and
wherein, to determine the target virtual prop corresponding to the virtual interaction object from among the at least one candidate virtual prop, the operations further comprise:
determining a first intersection in response to the detection ray pointing toward the virtual interaction object, the first intersection being an intersection between the detection ray and the first virtual interaction object;
according to position information of the first intersection, determining, from among the virtual interaction object, determining a first of the virtual interaction object toward which the view direction points; and
determining the target virtual prop corresponding to the first of the virtual interaction object from among the at least one candidate virtual prop.
